(19) United States
(12) Patent Application Publication
(10) Pub. No.: US 2005/0088087 A1
(43) Pub. Date: Apr. 28, 2005

(54) Organic electroluminescent bar and manufacturing method of the same

(75) Inventor: Takashi Ogawa, Anpachi-gun (JP)

Correspondence Address: Barry E. Bretschneider;Morrison & Foerster LLP, Suite 300, 1650 Tysons Boulevard, McLean, VA, 22102, US

(73) Assignee: Sanyo Electric Co., Ltd., Moriguchi-city (JP)

(21) Appl. No.: 10/944,412

(22) Filed: Sep. 20, 2004

(30) Foreign Application Priority Data
Sep. 30, 2003 (JP) 2003-340651

(51) Int. Cl. H05B 33/00

(52) U.S. Cl. 313/511; 313/506; 313/512

(57) ABSTRACT

The invention provides a bar-shaped light source emitting light electrically and a manufacturing method thereof, where the light source is minimized and power consumption is reduced. The organic EL bar has an anode having a bar shape (e.g. made of ITO) in a center of the organic EL bar. On a surface of the anode, an organic layer is formed to cover the surface. The organic layer is formed of a hole transport layer, an emissive layer, and an electron transport layer. On a surface of the organic layer, a transparent cathode transmitting light (e.g. a thin film made of aluminum and so on) is formed to cover the surface. The anode and the transparent cathode are connected with a power supply voltage. Light emitted from the organic layer is emitted outside through the transparent cathode.

### CROSS-REFERENCE OF THE INVENTION

This invention is based on Japanese Patent Application No. 2003-340651, the content of which is incorporated by reference in its entirety.

### BACKGROUND OF THE INVENTION

1. Field of the Invention

This invention relates to an organic electroluminescent bar and a manufacturing method thereof.

2. Description of the Related Art

Conventionally, a fluorescent lamp, a neon tube, a penlight, and so on have been known as a bar-shaped light source.

Furthermore, an electroluminescent light source using electroluminescent (hereafter, referred to as EL) elements has been known. An EL light source is disclosed, for example, in Japanese Patent Application Publication No. 2002-175029.

However, the conventional light source such as the fluorescent lamp has difficulty in size reduction (e.g. forming thinner). Furthermore, it has been difficult to reduce power consumption.

### SUMMARY OF THE INVENTION

This invention is directed to providing a small organic EL bar with reduced power consumption.

The invention provides a light emitting bar that includes a first electrode of a bar shape, an organic electroluminescent layer covering a surface of the first electrode, and a second electrode covering a surface of the organic electroluminescent layer. The first electrode may be coated on a support bar rather than having a bar shape of its own.

The invention also provides a method of manufacturing a light emitting bar. The method includes providing a first electrode of a bar shape, vapor-depositing an organic layer on a surface of the first electrode while rotating the first electrode around a center axis of the first electrode, and vapor-depositing a second electrode on a surface of the organic layer while rotating the first electrode vapor-deposited with the organic layer around the center axis of the first electrode. The first electrode may be coated on a support bar rather than having a bar shape of its own.

### BRIEF DESCRIPTION OF THE DRAWINGS

FIGS. 1A and 1B are a schematic perspective view and a cross-sectional view of an organic EL bar of an embodiment of the invention

FIG. 2 shows a manufacturing method of the organic EL bar of the embodiment of the invention.

### DETAILED DESCRIPTION OF THE INVENTION

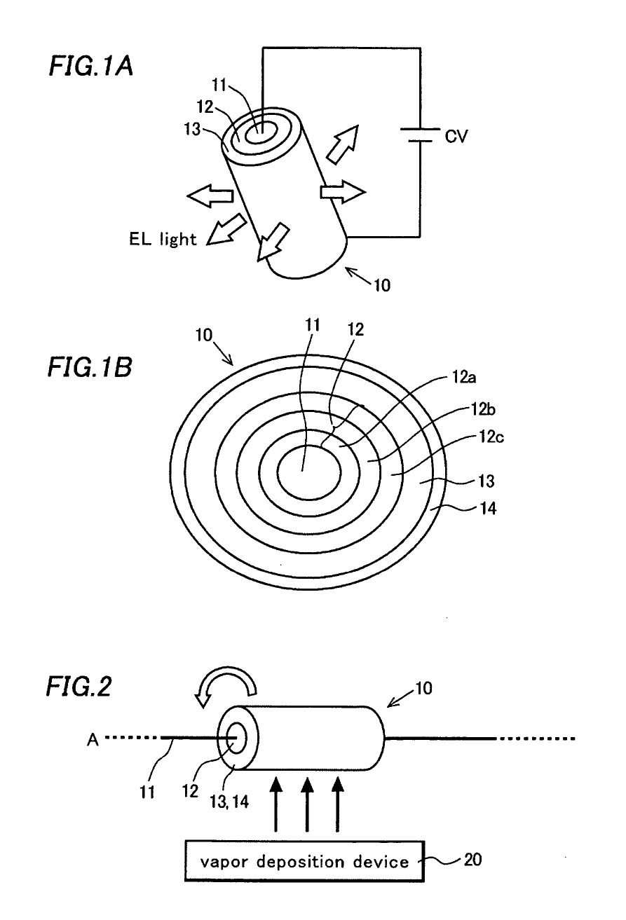

An embodiment of an organic EL bar of the invention will be described with reference to the drawings. FIGS. 1A and 1B are views showing a structure of the organic EL bar of this embodiment.

FIG. 1A is a schematic perspective view of the structure of the organic EL bar 10. As shown in FIG. 1A, the organic EL bar 10 has an anode 11, e.g. made of ITO (indium tin oxide), having a bar shape, e.g. cylindrical shape, in a center of the organic EL bar 10. An organic layer 12 is formed on the surface of the anode 11 to cover the surface. A transparent cathode 13 transmitting light, e.g. aluminum having a thickness of several to several ten nm, is formed on the surface of the organic layer 12, to cover the surface. A power supply voltage CV is applied between the anode 11 and the transparent cathode 13. Note that the transparent cathode 13 can be a half transparent electrode.

The organic layer 12 emits light by a current supplied from the power supply voltage CV through the anode 11 and the transparent cathode 13. That is, holes injected from the anode 11 and electrons injected from the transparent cathode 13 are recombined inside the organic layer 12 in the organic EL bar 10. These recombined holes and electrons generate excitons by excitation of organic molecules forming the organic layer 12. Light is emitted from the organic layer 12 in a process of radiation of the excitons, and then released radially from the organic EL bar 10 through the transparent cathode 13, thereby completing light-emission.

Next, the structure of the organic EL bar 10 will be described in detail with reference to FIG. 1B. FIG. 1B is a cross-sectional view of the organic EL bar 10 shown in FIG. 1A.

As shown in FIG. 1B, the organic layer 12 is formed to cover the surface of the anode 11. This organic layer 12 is formed by laminating a hole transport layer 12a, an emissive layer 12b, and an electron transport layer 12c, in this order. The hole transport layer 12a, the emissive layer 12b, and the electron transport layer 12c are formed to have a structure as shown below, for example.

The hole transport layer 12a is formed of a first hole transport layer made of MTDATA (4, 4, 4-tris (3-methylphenylphenylamino) triphenylamine) and a second hole transport layer made of TPD (4, 4-bis (3-methylphenylphenylamino) biphenyl). The emissive layer 12b is made of Bebq2 (bis(10-hydroxybenzo[h]quinolinato)beryllium) containing quinacridone, and the electron transport layer 12c is made of Bebq2.

The transparent cathode 13 is formed to cover the surface of the organic layer 12. It is preferable to form on the surface of the transparent cathode 13 a sealing layer 14 having a function of inhibiting moisture infiltration. Preferably, the sealing layer 14 is made of a material having characteristics enabling light transmission, for example, parylene.

As described above, the organic EL bar 10 can realize a bar-shaped light source, so that the bar-shaped light source can made smaller than the conventional bar-shaped light source such as a fluorescent lamp. Furthermore, the light source of the organic EL bar 10 enables reduction of power consumption for light emission.

The organic layer 12 described above has a three-layered structure made of the hole transport layer 12a, the emissive layer 12b, and the electron transport layer 12c. However, the embodiment is not limited to this, and the organic layer 12 can have a multiple-layered structure made of others, e.g. a hole injection layer and an electron injection layer in addition to the above three layers, or a single-layered structure made of an emissive layer.

The anode 11 is not limited to a cylindrical shape. For example, its cross section may be oval or polygonal. Alternatively, the anode 11 can be a tubular shape, having a hole in a center thereof.

Next, a manufacturing method of the organic EL bar 10 described above will be described with reference to FIG. 2. FIG. 2 is a view showing a manufacturing method of the organic EL bar 10 of this embodiment.

As shown in FIG. 2, the anode 11 having a bar shape is placed above a vapor deposition device 20. Although not shown, a rotation mechanisms is provided on an end portion of the anode 11 and connected to it. This rotation mechanism rotates the anode 11 around a rotation axis A, a center of a cross section of the anode 11, of the rotating the anode 11.

Then, while the anode 11 is rotated around the rotation axis A by the rotation mechanism, an organic material emitted from the vapor deposition device 20 is vapor-deposited on the surface of the anode 11. The hole transport layer 12a, the emissive layer 12b, and the electron transport layer 12c for forming the organic layer 12 are vapor-deposited in this order.

Next, while the anode 11 vapor-deposited with the organic layer 12 is rotated around the rotation axis A by the rotation means, a material of the transparent cathode 13 is vapor-deposited on the surface of the organic layer 12. It is preferable to use a CAT-CVD (catalytic chemical vapor deposition) method or an ECR-CVD (electron cyclotron resonance chemical vapor deposition) method for the vapor-deposition of the transparent cathode 13 on the surface of the organic layer 12. These CAT-CVD and ECR-CVD methods enable easy formation of the transparent cathode 13 as a vapor-depositing layer without damaging the organic layer 12 as a layer underneath.

Next, while the anode 11 vapor-deposited with the organic layer 12 and the transparent cathode 13 is rotated around the rotation axis A by the rotation mechanism, a material of the sealing layer 14, e.g. parylene, is vapor-deposited on the surface of the transparent cathode 13.

The manufacturing method of the organic EL bar 10 described above can easily realize the bar-shaped light source which can be made smaller than the bar-shaped light source such as a fluorescent lamp formed by the conventional manufacturing method.

In the embodiment described above, the organic EL bar 10 is formed to have the bar-shaped anode 11 in the center thereof. However, the embodiment is not limited to this and the anode can be vapor-deposited around a support bar, e.g. having a cylindrical shape, and the organic layer 12 can be formed on the surface of anode 11 by the same method as the manufacturing method described above. When the anode formed around the support bar is made of ITO (indium tin oxide) enabling light transmission, it is preferable that the support bar is formed of a material such as Ag (silver) which reflects light without transmission. With this structure, when light emitted from the organic layer 12 is emitted toward the center of the organic EL bar 10 through the anode made of ITO, effective light emission can be realized since the support bar reflects the light toward outside.

The shape of the support bar described above is not limited to a cylindrical shape and can have a cross section formed in any one of various shapes such as an oval cross section or a polygonal cross section. Alternatively, the support bar can have a circular shape, having a hole in a center thereof.

In the embodiment described above, the organic EL bar 10 is formed by laminating the anode 11, the organic layer 12, the transparent cathode and the sealing layer 14 in this order from the center of the organic EL bar 10. However, the embodiment is not limited to this, and the organic EL bar 10 can be formed by laminating a cathode made of metal such as Al (aluminum), an organic layer a transparent anode transmitting light, e.g. made of ITO, and a sealing layer in this order from the center of the organic EL bar 10.

In this case, the organic layer is formed by laminating an electron transport layer, an emissive layer, and a hole transport layer, in this order. Here, the transparent anode made of ITO is formed on the organic layer by sputtering. Generally, when particles of ITO are deposited on the organic layer by sputtering, the organic layer as a layer to be attached is damaged. Therefore, a protection layer, e.g. CUPC, is vapor-deposited on the surface of the hole transport layer which is a top layer of the organic layer, and then the transparent anode made of ITO is formed thereon. In the embodiment described above, the sealing layer 14 is formed to cover the surface of the transparent cathode 13. However, the invention includes the organic EL bar 10 which does not have the sealing layer 14.

1. A light emitting bar comprising:
a first electrode of a bar shape;
an organic electroluminescent layer covering a surface of the first electrode; and
a second electrode covering a surface of the organic electroluminescent layer.

2. The light emitting bar of claim 1, further comprising a sealing layer covering a surface of the second electrode.

3. The light emitting bar of claim 1, wherein the first electrode is configured to operate as an anode, and the second electrode is configured to operate as a cathode.

4. The light emitting bar of claim 1, wherein the first electrode is configured to operate as a cathode, and the second electrode is configured to operate as an anode.

5. The light emitting bar of claim 1, wherein the organic luminescent layer comprises a hole transport layer, an emissive layer and an electron transport layer.

6. The light emitting bar of claim 1, wherein a cross section of the first electrode is circular, oval or polygonal.

7. A light emitting bar comprising:
a support bar;
a first electrode covering a surface of the support bar;
an organic electroluminescent layer covering a surface of the first electrode; and
a second electrode covering a surface of the organic electroluminescent layer.

8. The light emitting bar of claim 7, further comprising a sealing layer covering a surface of the second electrode.

9. The light emitting bar of claim 7, wherein the first electrode is configured to operate as an anode, and the second electrode is configured to operate as a cathode.

10. The light emitting bar of claim 7, wherein the first electrode is configured to operate as a cathode, and the second electrode is configured to operate as an anode.

11. The light emitting bar of claim 7, wherein the organic luminescent layer comprises a hole transport layer, an emissive layer and an electron transport layer.

12. The light emitting bar of claim 7, wherein a cross section of the support bar is circular, oval or polygonal.

13. The light emitting bar of claim 7, wherein a cross section of the support bar covered by the first electrode is circular, oval or polygonal.

14. A method of manufacturing a light emitting bar, comprising:
providing a first electrode of a bar shape;
vapor-depositing an organic layer on a surface of the first electrode while rotating the first electrode around a center axis of the first electrode; and
vapor-depositing a second electrode on a surface of the organic layer while rotating the first electrode vapor-deposited with the organic layer around the center axis of the first electrode.

15. The light emitting bar of claim 14, further comprising vapor-depositing a sealing layer on a surface of the second electrode while rotating the first electrode vapor-deposited with the organic layer and the second electrode around the center axis of the first electrode.

16. The method of claim 14, further comprising connecting the first electrode to an anode source and connecting the second electrode to a cathode source.

17. The method of claim 14, further comprising connecting the first electrode to a cathode source and connecting the second electrode to an anode source.

18. The method of claim 14, wherein the vapor-depositing of the organic layer on the surface of the first electrode comprises vapor-depositing an organic electroluminescent layer on the surface of the first electrode.

19. The method of claim 14, wherein the vapor-depositing of the organic layer on the surface of the first electrode comprises vapor-depositing a hole transport layer, vapor-depositing an emissive layer and vapor-depositing an electron transport layer.

20. The method of claim 14, wherein a cross section of the first electrode is circular, oval or polygonal.

21. A method of manufacturing a light emitting bar, comprising:
providing a support bar;
vapor-depositing a first electrode on a surface of the support bar while rotating the support bar around a center axis of the support bar;
vapor-depositing an organic layer on a surface of the first electrode while rotating the support bar vapor-deposited with the first electrode around the center axis of the support bar; and
vapor-depositing a second electrode on a surface of the organic layer while rotating the support bar vapor-deposited with the first electrode and the organic layer around the center axis of the support bar.

22. The light emitting bar of claim 21, further comprising vapor-depositing a sealing layer on a surface of the second electrode while rotating the support bar vapor-deposited with the first electrode, the organic layer and the second electrode around the center axis of the support bar.

23. The method of claim 21, further comprising connecting the first electrode to an anode source and connecting the second electrode to a cathode source.

24. The method of claim 21, further comprising connecting the first electrode to a source and connecting the second electrode to an anode source.

25. The method of claim 21, wherein the vapor-depositing of the organic layer on the surface of the first electrode comprises vapor-depositing an organic electroluminescent layer on the surface of the first electrode.

26. The method of claim 21, wherein the vapor-depositing of the organic layer on the surface of the first electrode comprises vapor-depositing a hole transport layer, vapor-depositing an emissive layer and vapor-depositing an electron transport layer.

27. The method of claim 21, wherein a cross section of the support bar is circular, oval or polygonal.

28. The method of claim 21, wherein the first electrode is vapor deposited on the surface of the support bar so that a cross section of the support bar vapor-deposited with the first electrode is circular, oval or a polygonal.
